(19) United States
(12) Patent Application Publication
(10) Pub. No.: US 2007/0291330 A1
(43) Pub. Date: Dec. 20, 2007

(54) Optical Transparent Media Adapter with Magnetically Coupled Optics and Light Guide

(76) Inventor: Kurt Eugene Spears, La Jolla, CA (US)

Correspondence Address: HDSL, 4331 STEVENS BATTLE LANE, FAIRFAX, VA, 22033, US

(21) Appl. No.: 11/424,848

(22) Filed: Jun. 16, 2006

(51) Int. Cl. H04N 1/04

(52) U.S. Cl. 358/506; 358/487

(57) ABSTRACT

A thin transparent media adapter is used when scanning transparent media on a contact image sensor or reduction optics scanner. The adapter uses illumination from a light guide assembly to illuminate a diffuser and the media. A lens assembly is used to focus the light from the media to create an intermediate image between the adapter and the scanner platen glass. The adapter is an optical assembly that forms an intermediate image of the transparent media in the object side focal plane of existing scanner optics. The existing scanner optics can then capture and focus the light from the intermediate image onto the scanner's existing sensor array. The adapter magnetically couples to the scan system to allow the lens array to follow movement of the optical system of the scanner.

### BACKGROUND OF THE INVENTION

1. Field of the Invention

The present invention relates to an optical scanning system. More specifically, the present invention discloses an optical adapter that magnetically couples with a contact image sensor scanner module for effectively scanning transparent media.

2. Description of the Prior Art

A conventional image scanner is capable of producing digital images from printed text or photographic images. In the tradition system, an opaque media is place on the platen glass of the scanner. A light source in the scanner emits light onto the opaque media in order to illuminate the media. Light is reflected off the media and is picked up by a series of lenses or a lens array. The lens array focuses the reflected light onto a sensor array which captures the light in order to produce the digital image of the opaque media. However, while the conventional image scanner is useful when used with opaque media, it is ineffective when used with transparent media.

Opaque media is capable of reflecting light whereas the light emitted from the scanner light source will simply pass through the transparent media. As a result, the sensor array is unable to detect a useful amount of light and cannot capture an accurate image of the transparent media. Therefore until now, it was necessary to utilize a dedicated scanner for transparent media.

A dedicated transparent media scanner houses the light source in a cover over the top of the transparent media and emits the light on the back of the media. The lens array mounted in the bottom of the scanner then focuses the light onto the sensor array. The sensor array captures the light in order to capture a digital image of the transparent media. However, this transparent media scanner is relatively expensive since either a large area light emitting panel or a small panel with an additional motor and drive system are also required in the cover. Also, contact image sensor scan modules utilize lens arrays that have very short depth of focus that limits the range of transparent media types that can be scanned. Additionally, alignment and coordination between the bottom system and cover system is complex and prone to misalignment. Furthermore, it is a waste of resources to require the need for a dedicated transparent media scanner when a conventional image scanner can be adapted to scan transparent media.

Therefore there is need for an optical transparent media adapter that efficiently flattens and backlights transparent media and which can be used with a contact image sensor type of scanner module.

### SUMMARY OF THE INVENTION

To achieve these and other advantages and in order to overcome the disadvantages of the conventional method in accordance with the purpose of the invention as embodied and broadly described herein, the present invention provides a media adapter with magnetically coupled optics and light guide for scanning transparent media.

The transparent media adapter (TMA) can be utilized for scanning transparent media on contact image sensor (CIS) scanners. The present invention provides an optical assembly that forms an intermediate image of the transparent media in the object side focal plane of the existing scanner optics. The existing scanner optics can then capture and focus the light from the intermediate image onto the scanner's existing linear sensor array.

The TMA of the present invention comprises a lens assembly, a light guide assembly, a diffuser, and a media holder. The TMA uses illumination from the light guide assembly to illuminate the diffuser and media. The lens assembly is used to focus the light from the media to create an intermediate image between the TMA and scanner platen glass.

A magnet attached to the lens assembly magnetically couples with the optical system of a scanner. As the optical system moves, the lens assembly follows the movement. This allows the lens assembly to follow the movement of the scanner as it scans and allows the lens assembly and the underlying scan module to properly align and move in a synchronized manner.

The present invention has the advantage of providing a compact, low cost transparent media adapter that can be magnetically coupled to the scan system. This allows the cost of the transport system to be reduced because the need for a motor and drive belt are eliminated. The TMA captures a large amount of light and all the light can be transmitted to the underlying scanner module. Additionally, the TMA has the advantage that it can create an intermediate image of the transparent media in the correct focal plane for the underlying scan module. This is particularly important for CIS based scanners because they have very shallow depth of field and cannot scan media that is above the platen glass.

As a result, the present invention solves the problem of how to flatten and backlight transparent media in a scanner and how to locate the media in the focal plane of the module, which is typically located very close to the top surface of the platen glass. Additionally, the present invention reduces the cost and complexity of the TMA solution.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a side view of an optical system of an image scanner and transparent media adapter with magnetically coupled optics and light guide according to an embodiment of the present invention;

FIG. 2 is a drawing illustrating a side view of an optical system of an image scanner and transparent media adapter module using long total conjugate lens according to an embodiment of the present invention; and

FIG. 3 is a drawing illustrating the relationship between lens diameter and light angles according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

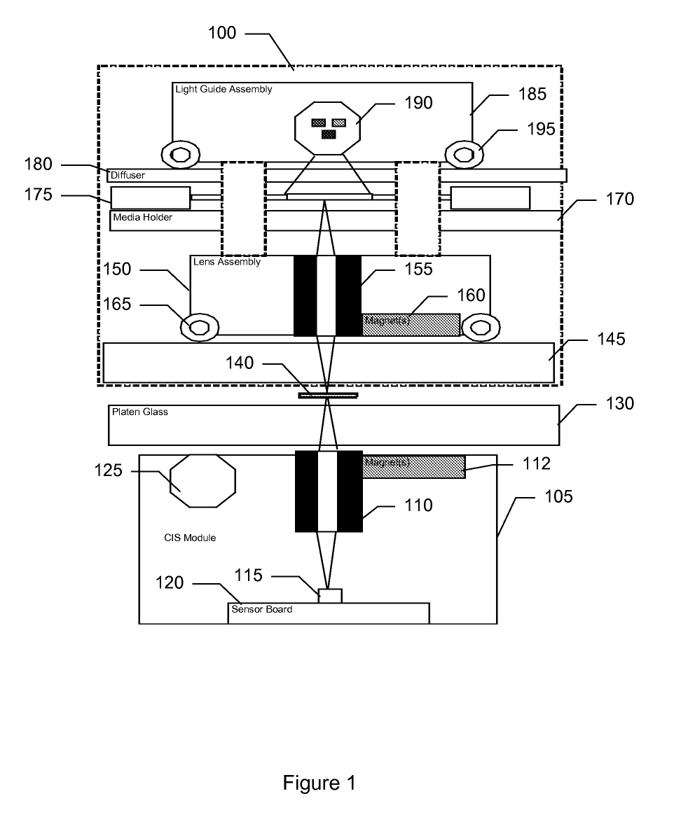

Refer to FIG. 1, which is a drawing illustrating a side view of an optical system of an image scanner and transparent media adapter with magnetically coupled optics and light guide according to an embodiment of the present invention.

As shown in FIG. 1, the CIS scanner module 105 of the image scanner comprises a sensor board 120 with a sensor array 115, a light source 125, and a lens array 1110. The CIS module 125 is the existing scan module in the scanner. On the top of the image scanner is platen glass 130 on which the transparent media adapter of the present invention rests.

The transparent media adapter module 100 comprises a media holder 170, a diffuser 180, a light guide assembly 185, and a lens assembly 150. The media holder 170 positions and holds the transparent media 175. On top of the media holder 170 and transparent media 175 is a diffuser 180 for diffusing light. The light guide assembly 185 comprises a light source 190 for illuminating the transparent media 175. On the bottom of the light guide assembly 195 are wheels that facilitate movement of the light guide assembly 185.

The lens assembly 150 comprises a lens array 155. Similar to the light guide assembly 185, the lens assembly 150 has wheels 165 on the bottom of the assembly 150 which roll across glass 145. A magnet 160 or a plurality of magnets is disposed on the lens assembly 150 for magnetically coupling with a magnet 112 connected to the optical system of the scanner module 105.

In the embodiment illustrated in FIG. 1, the light guide assembly 185 is connected to the lens assembly 150. This allows the light guide assembly 185 and lens assembly 150 to move together. However, in other embodiments a magnet or a plurality of magnets is disposed on the light guide assembly to magnetically couple with the lens assembly.

In operation, the TMA 100 uses illumination from the light source 190 of the light guide assembly 185 to illuminate the diffuser 180 and transparent media 175. The light source 125 in the scanner module 105 is disabled when the TMA 100 is operating. The lens assembly 150 is used to focus the light from the media to create an intermediate image 140 between the TMA 100 and the scanner platen glass 130. In FIG. 1, the scanner module 105 uses a lens array 110, such as the 12E lens array from Nippon Sheet Glass, to focus the intermediate image 140 onto the sensor array 110 to enable the scanner module 105 to capture an image of the media 175.

As the optical system of the scanner module 105 moves the magnetically coupled light guide assembly 185 and lens assembly 150 follow the optical system. In this way, as the light guide assembly 185 illuminates a portion of the media 175, an intermediate image 140 of the media 175 is formed by the lens assembly 150 and captured by the sensor array 115. As the optical system continues to move across the media 175, this process continues until a complete image of the media 175 is captured.

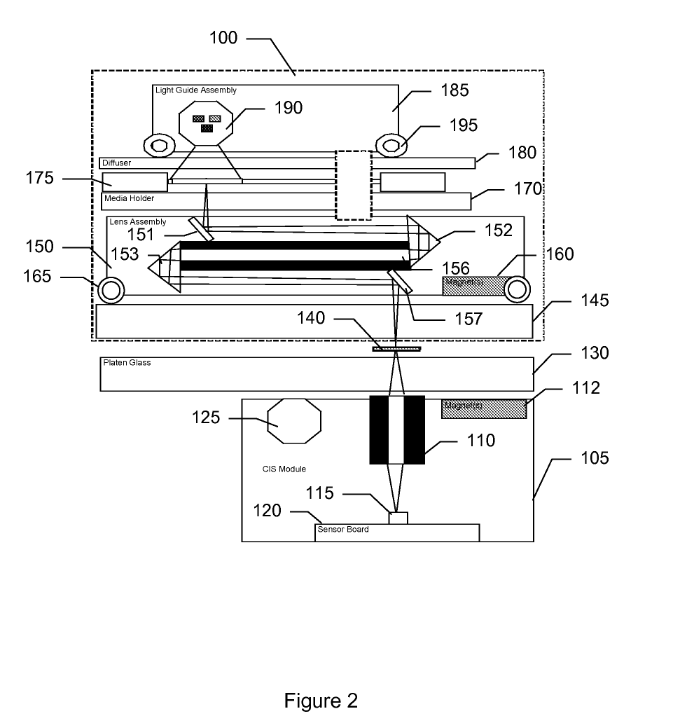

Refer to FIG. 2, which is a drawing illustrating a side view of an optical system of an image scanner and transparent media adapter module using long total conjugate lens according to an embodiment of the present invention. The TMA illustrated in FIG. 2 is similar to the one in FIG. 1 but with an alternative lens assembly. In FIG. 1, a lens array with a short total conjugate length, such as the 12E lens array, is utilized to form the intermediate image of the media. However, in FIG. 2, the lens assembly utilizes long total conjugate lens array such as the 12B lens array from Nippon Sheet Glass.

Since the 12B lens array 156 is relatively long it is impractical to place the lens array 156 vertically. Therefore, in FIG. 2 the lens array 156 is placed horizontally and a plurality of mirrors or prisms is used to reflect the image of the media 175 illuminated by the light guide assembly 185. In this embodiment a first mirror 151 reflects the light from the media 175 towards a first prism 152 at approximately 90 degrees. The first prism 152 reflects this light and through the lens array 156 towards a second prism 153. The first prism 152 reflects the light from the first mirror 151 by approximately 180 degrees. The second prism 153 reflects the light from the first prism 152 by approximately another 180 degrees towards a second mirror 157. The second mirror 157 reflects the light by approximately 90 degrees to form an intermediate image 140 of the media 175 between the TMA 100 and the scanner platen glass 130.

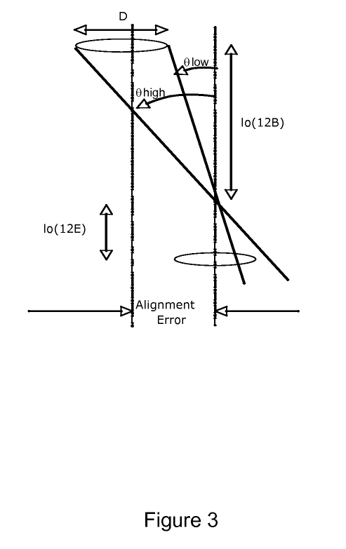

Refer to FIG. 3, which is a drawing illustrating the relationship between lens diameter and light angles according to an embodiment of the present invention. FIG. 3 also shows the relationship of the two lens arrays 12B and 12E.

For the 12E lens array shown on the bottom of FIG. 3, the capture angle is approximately 6 degrees in the y direction and 12 degrees in the x direction (along the scan line). For the 12B lens array, the light angles at the intermediate image allow the image to be completely captured provided the 12E and 12B are aligned to approximately +/−0.5 mm. Beyond this range, the percentage of light captured decreases as the misalignment increases. This means it is important to achieve good alignment and good magnetic tracking to capture all the light present in the intermediate image.

An advantage of the present invention is that since the lens assembly, light guide assembly, and optical system of the scanner module are magnetically coupled, no motor or drive assembly are required in the TMA. This saves expense and reduces complexity of the TMA Additionally, the magnets that are used to couple the existing scan module allow the TMA and the underlying scan module to properly align and move in a synchronized manner. The magnets keep the TMA aligned with the scan module as it moves from left to right or from right to left.

In another embodiment of the present invention, the light guide assembly, lens assembly, or scan module use a metal plate instead of a magnet, as long as the magnet on the other module is strong enough to provide sufficient coupling to the metal plate. For example, when using a scan module with a metal plate instead of a magnet installed, positioning a magnet or magnets on the lens assembly allows the magnet of the lens assembly to couple with the scan module and follow the scan module movement. Alternatively, a metal plate is attached to light guide assembly. A magnet on the lens assembly couples to the metal plate and allows the light guide assembly to move with the lens assembly.

In another embodiment of the present invention, the light guide assembly, lens assembly, or scan module use an electromagnet instead of a magnet, as long as the electromagnet is strong enough to provide sufficient coupling to the other module. For example, when using a scan module with an electromagnet instead of a magnet installed, positioning a magnet or magnets on the lens assembly allows the magnet of the lens assembly to couple with the electromagnet on the scan module and follow the scan module movement.

In the embodiments illustrated in FIG. 1 and FIG. 2, wheels are attached to the lens assembly and light guide assembly. However, in other embodiments of the present invention slides are used in place of the wheels. The slides are made of a low friction material that allows the assemblies to easily slide and follow the movement of the optical system.

As described above, the present invention provides a compact, low cost transparent media adapter that is magnetically coupled to the scan system. This allows the cost of the transport system to be reduced because the need for a motor and drive system are eliminated.

The present invention backlights the transparent media so it can be imaged by the underlying scanner module. The lens assembly captures a significant amount of light and focuses the light to create an intermediate image of the media.

The transparent media adapter with magnetically coupled optics and light guide of the present invention solves the problem of how to flatten and backlight transparent media for a CIS or reduced optics based scanner. The magnetic coupling allows the optics and illumination to be optimized for a narrow region that moves in sync with the scan module.

Furthermore, the present invention has the advantage that it can transfer the media image to the correct focal plane for the underlying scan module. This is particularly important for CIS based scanners because they have very shallow depth of field and cannot scan media that is above the platen glass.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An optical transparent media adapter for a scanner module, comprising:
a media holder for holding transparent media;
a light guide assembly for illuminating the transparent media;
a lens assembly for focusing light from the transparent media to create an intermediate image of the transparent media; and
at least one lens assembly coupling means for magnetically coupling the lens assembly to an optical system of the scanner module.

2. The optical transparent media adapter of claim 1, further comprising:
at least one light guide assembly coupling means for magnetically coupling the light guide assembly to the lens assembly.

3. The optical transparent media adapter of claim 1, further comprising:
at least one optical system coupling means for magnetically coupling the optical system of the scanner module to the lens assembly.

4. The optical transparent media adapter of claim 1, the lens assembly coupling means comprising at least one magnet or electromagnet.

5. The optical transparent media adapter of claim 2, the light guide assembly coupling means comprising at least one magnet or electromagnet.

6. The optical transparent media adapter of claim 3, the optical system coupling means comprising at least one magnet or electromagnet.

7. The optical transparent media adapter of claim 1, further comprising:
a diffuser between the light guide assembly and the transparent media for diffusing light emitted by the light guide assembly.

8. The optical transparent media adapter of claim 1, the lens assembly further comprising a lens array.

9. The optical transparent media adapter of claim 8, where the lens array is a unity magnification lens array.

10. The optical transparent media adapter of claim 1, the lens assembly comprising:
a lens array; and
a plurality of reflective surfaces for reflecting light from the transparent media through the lens array to create the intermediate image of the transparent media.

11. The optical transparent media adapter of claim 1, the lens assembly comprising:
a first mirror for reflecting light from the transparent media;
a first prism for reflecting light from the first mirror;
a second prism for reflecting light from the first prism;
a second mirror for reflecting light from the second prism; and
a lens array between the first prism and the second prism.

12. The optical transparent media adapter of claim 11, where the lens array is a unity magnification lens array.

13. The optical transparent media adapter of claim 1, the lens assembly further comprising a plurality of wheels or a plurality of slides for facilitating movement of the lens assembly.

14. The optical transparent media adapter of claim 1, the light guide assembly further comprising a plurality of wheels or a plurality of slides for facilitating movement of the light guide assembly.

15. The optical transparent media adapter of claim 1, the light guide assembly further comprising a light source.

16. An optical transparent media adapter for a scanner module, comprising:
a media holder for holding transparent media;
a light guide assembly for illuminating the transparent media;
a diffuser between the light guide assembly and the transparent media for diffusing light emitted by the light guide assembly;
a lens assembly for focusing light from the transparent media to create an intermediate image of the transparent media; and
at least one lens assembly coupling means for magnetically coupling the lens assembly to an optical system of the scanner module.

17. The optical transparent media adapter of claim 16, further comprising:
at least one light guide assembly coupling means for magnetically coupling the light guide assembly to the lens assembly.

18. The optical transparent media adapter of claim 16, further comprising:
at least one optical system coupling means for magnetically coupling the optical system of the scanner module to the lens assembly.

19. The optical transparent media adapter of claim 16, the lens assembly coupling means comprising at least one magnet or electromagnet.

20. The optical transparent media adapter of claim 17, the light guide assembly coupling means comprising at least one magnet or electromagnet.

21. The optical transparent media adapter of claim 18, the optical system coupling means comprising at least one magnet or electromagnet.

22. The optical transparent media adapter of claim 16, the lens assembly further comprising a lens array.

23. The optical transparent media adapter of claim 22, where the lens array is a unity magnification array.

24. The optical transparent media adapter of claim 16, the lens assembly comprising:
a lens array; and
a plurality of reflective surfaces for reflecting light from the transparent media through the lens array to create the intermediate image of the transparent media.

25. The optical transparent media adapter of claim 16, the lens assembly comprising:
a first mirror for reflecting light from the transparent media;
a first prism for reflecting light from the first mirror;
a second prism for reflecting light from the first prism;
a second mirror for reflecting light from the second prism; and
a lens array between the first prism and the second prism.

26. The optical transparent media adapter of claim 25, where the lens array is a unity magnification lens array.

27. The optical transparent media adapter of claim 16, the lens assembly further comprising a plurality of wheels or a plurality of slides for facilitating movement of the lens assembly.

28. The optical transparent media adapter of claim 16, the light guide assembly further comprising a plurality of wheels or a plurality of slides for facilitating movement of the light guide assembly.

29. The optical transparent media adapter of claim 16, the light guide assembly further comprising a light source.

30. An optical transparent media adapter for a scanner module, comprising:
a media holder for holding transparent media;
a light guide assembly for illuminating the transparent media;
a plurality of light guide assembly wheels or slides for facilitating movement of the light guide assembly;
a diffuser between the light guide assembly and the transparent media for diffusing light emitted by the light guide assembly;
a lens assembly for focusing light from the transparent media to create an intermediate image of the transparent media;
a plurality of lens assembly wheels or slides for facilitating movement of the lens assembly; and
at least one lens assembly coupling means for magnetically coupling the lens assembly to an optical system of the scanner module.

31. The optical transparent media adapter of claim 30, further comprising:
at least one light guide assembly coupling means for magnetically coupling the light guide assembly to the lens assembly.

32. The optical transparent media adapter of claim 30, further comprising:
at least one optical system coupling means for magnetically coupling the optical system of the scanner module to the lens assembly.

33. The optical transparent media adapter of claim 30, the lens assembly coupling means comprising at least one magnet or electromagnet.

34. The optical transparent media adapter of claim 31, the light guide assembly coupling means comprising at least one magnet or electromagnet.

35. The optical transparent media adapter of claim 32, the optical system coupling means comprising at least one magnet or electromagnet.

36. The optical transparent media adapter of claim 30, the lens assembly further comprising a lens array.

37. The optical transparent media adapter of claim 36, where the lens array is a unity magnification array.

38. The optical transparent media adapter of claim 30, the lens assembly comprising:
a lens array; and
a plurality of reflective surfaces for reflecting light from the transparent media through the lens array to create the intermediate image of the transparent media.

39. The optical transparent media adapter of claim 30, the lens assembly comprising:
a first mirror for reflecting light from the transparent media;
a first prism for reflecting light from the first mirror;
a second prism for reflecting light from the first prism;
a second mirror for reflecting light from the second prism; and
a lens array between the first prism and the second prism.

40. The optical transparent media adapter of claim 39, where the lens array is a unity magnification lens array.

41. The optical transparent media adapter of claim 30, the light guide assembly further comprising a light source.
